(19) United States
(12) Patent Application Publication
(10) Pub. No.: US 2017/0357966 A1
(43) Pub. Date: Dec. 14, 2017

(54) METHOD AND SYSTEM FOR USE OF A PROPRIETARY PRIVATE BLOCKCHAIN

(71) Applicant: MasterCard International Incorporated, Purchase, NY (US)

(72) Inventors: Arundhati CHANDRASEKHAR, New York, NY (US); Pranav GANDHI, New York, NY (US); Brittany Hope BERLINER, Sands Point, NY (US); Zachary WIDDICOMBE, Saint Charles, MO (US)

(73) Assignee: MasterCard International Incorporated, Purchase, NY (US)

(21) Appl. No.: 15/177,690

(22) Filed: Jun. 9, 2016

(51) Int. Cl. G06Q 20/38

(52) U.S. Cl. CPC G06Q 20/3829; G06Q 2220/00

(57) ABSTRACT

A method for submitting data captured in a transaction message to a blockchain includes: storing account profiles, each including data related to a transaction account including a primary account number and fiat currency balance; receiving a transaction message including a specific primary account number, fiat transaction amount, and merchant identifier; adjusting the fiat currency balance in a specific account profile that includes the specific primary account number by the fiat transaction amount; generating a data message including a token identifier associated with the specific account profile, the fiat transaction amount, and the merchant identifier; and electronically transmitting the generated data message to a computing device operating as a node in a blockchain network.

### FIELD

The present disclosure relates to the use of a proprietary private blockchain, specifically the submitting of data captured in a transaction message to a blockchain for clearing and settlement for the transaction using a private blockchain as an alternative to traditional transaction settlement.

### BACKGROUND

Traditionally, when a consumer conducts a payment transaction with a merchant that is processed by a payment network, it is expected that an issuing financial institution associated with the consumer will pay the transaction amount to an acquiring financial institution associated with the merchant. As transactions conducted by each entity can number in the thousands, millions, or even billions on any given day, it can become inefficient, and in some cases impossible, due to payment network limitations on available processing bandwidth and computing power for the issuing financial institution to pay the transaction amount immediately to the merchant once the transaction is conducted. As a result, financial institutions often tabulate debits and credits to other institutions based on payment transactions over time, and make a single currency transfer that is an aggregation of all of the transaction at once. In some cases, that period of time for settlement may be days, weeks, or even longer.

In many cases, an acquiring financial institution may be unable to credit a merchant's transaction account until the amount due to the merchant has been settled with the appropriate issuing financial institution. In instances where settlement may take several days or weeks, a merchant may be unable to receive the funds for a processed transaction until a significant amount of time has passed. For small merchants that may process a limited number of transactions, such as small businesses or individuals, or may process payment transactions for small transaction amounts, referred to herein as “micromerchants,” the inability to receive the funds for a transaction for such an amount of time may be detrimental to their business and/or livelihood.

Thus, there is a need for a technical solution to provide for faster, individualized settlement for payment transactions.

### SUMMARY

The present disclosure provides a description of systems and methods for submitting data captured in a transaction message to a blockchain. The use of a proprietary, private blockchain may enable payment transactions to be settled on an individual basis, not limited by payment network infrastructure and bandwidth, providing acquirers and merchants with more accurate accounting. In addition, settlement on an individual basis and using a proprietary, private blockchain can enable the transactions to be settled in a time measured in minutes rather than days or weeks, for faster crediting to the merchant. Accordingly, the present disclosure describes a technological improvement to issuing financial institutions systems to enable the settlement of payment transactions on an individual basis using a private blockchain.

A method for submitting data captured in a transaction message to a blockchain includes: storing, in an account database of a processing server, a plurality of account profiles, wherein each account profile includes a structured data set related to a transaction account including at least a primary account number and a fiat currency balance; receiving, by a receiving device of the processing server, a transaction message from a payment network, wherein the transaction message is formatted based on one or more standards and includes a plurality of data elements including a first data element configured to store a specific primary account number, a second data element configured to store a fiat transaction amount, and a third data element configured to store a merchant identifier; execute, by a querying module of the processing server, a query on the account database to adjust the fiat currency balance based on the fiat transaction amount stored in the second data element included in the received transaction message in a specific account profile where the included primary account number corresponds to the specific account number stored in the first data element included in the received transaction message; generating, by a generation module of the processing server, a data message including at least a token identifier associated with the specific account profile, the fiat transaction amount, and the merchant identifier; and electronically transmitting, by a transmitting device of the processing server, the generated data message to a computing device operating as a node in a blockchain network.

A system for initiating submitting data captured in a transaction message to a blockchain includes: an account database of a processing server configured to store a plurality of account profiles, wherein each account profile includes a structured data set related to a transaction account including at least a primary account number and a fiat currency balance; a receiving device of the processing server configured to receive a transaction message from a payment network, wherein the transaction message is formatted based on one or more standards and includes a plurality of data elements including a first data element configured to store a specific primary account number, a second data element configured to store a fiat transaction amount, and a third data element configured to store a merchant identifier; a querying module of the processing server configured to execute a query on the account database to adjust the fiat currency balance based on the fiat transaction amount stored in the second data element included in the received transaction message in a specific account profile where the included primary account number corresponds to the specific account number stored in the first data element included in the received transaction message; a generation module of the processing server configured to generate a data message including at least a token identifier associated with the specific account profile, the fiat transaction amount, and the merchant identifier; and a transmitting device of the processing server configured to electronically transmit the generated data message to a computing device operating as a node in a blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for settlement of a payment transaction using a proprietary, private blockchain in accordance with exemplary embodiments.

FIG. 2 is a block diagram illustrating the issuer processing server of FIG. 1 for the submitting of data captured in a transaction message to a private blockchain for settlement in accordance with exemplary embodiments.

FIGS. 3A and 3B are a flow diagram illustrating a process for performing settlement for a payment transaction using a private blockchain in accordance with exemplary embodiments.

FIG. 4 is a flow chart illustrating an exemplary method for submitting data captured in a transaction message to a blockchain in accordance with exemplary embodiments.

FIG. 5 is a flow diagram illustrating the processing of a payment transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc. In some embodiments, a blockchain may also consist of additional, and in some instances arbitrary, data that is confirmed and validated by the blockchain network through proof of work and/or any other suitable verification techniques associated therewith. In some cases, such data may be included in the blockchain as part of transactions, such as included in additional data appended to transaction data. In some instances, the inclusion of such data in a blockchain may constitute a transaction. In such instances, a blockchain may not be directly associated with a specific digital, virtual, fiat, or other type of currency.

### System for Transaction Settlement Using a Blockchain

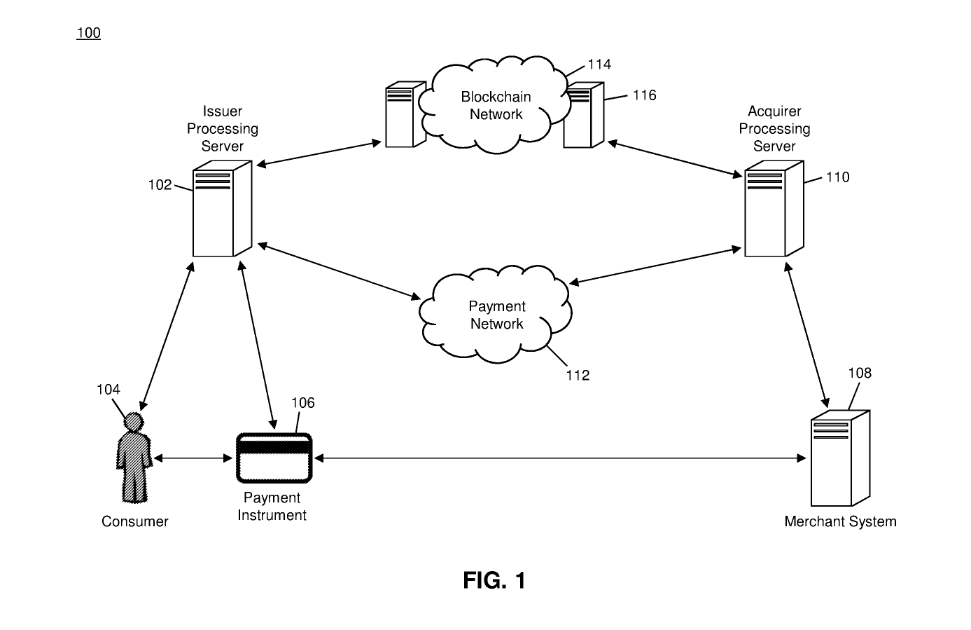

FIG. 1 illustrates a system 100 for the settlement of a payment transaction submitted to a payment network using a blockchain.

The system 100 may include an issuer processing server 102. The issuer processing server 102, discussed in more detail below, may be associated with an issuing financial institution, such as an issuing bank, or other entity configured to issue transaction accounts to consumers 104 for use in funding payment transactions. The issuer processing server 102 may be configured to perform the traditional functions of an issuing financial institution with respect to approval or denial of payment transactions, and may be further configured to perform settlement of payment transactions via a blockchain.

As part of the issuing of a transaction account to a consumer 104 for use in funding payment transactions, the issuing financial institution may issue a payment instrument 106 to the consumer 104. The payment instrument 106 may be associated with the issued transaction account and may be encoded with, may store, or otherwise associated with payment details corresponding to the associated transaction account. The payment details may include, for example, a primary account number for the associated transaction account, transaction counters, cryptograms, etc. The payment instrument 104 may be any suitable type of instrument, such as a physical credit card, a mobile communication device configured to store and electronically transmit payment details, etc.

The consumer 104 may initiate a payment transaction with a merchant. As part of the payment transaction, transaction details for the payment transaction may be entered into a merchant system 108, which may be a computing system associated with the merchant used in the processing of payment transactions, such as a point of sale system. Transaction details may include, for example, a transaction amount, transaction time, transaction date, geographic location, product data, offer data, reward data, loyalty data, merchant data, etc. Also as part of the initiation of the payment transaction, the consumer 104 may convey payment details for their associated transaction account to the merchant system 108 using the payment instrument 106. For example, the merchant system 108 may include a magnetic strip reader configured to read payment details encoded in a magnetic strip in a physical payment card, may include a receiving device configured to receive payment details transmitted by a communication device via near field communication, etc. In another example, the consumer 104 may engage with the merchant system 108 via an e-commerce transaction, where the consumer 104 may enter payment details into a computing device, such as a desktop computer, smart phone, wearable computing device, etc., for electronic transmission to the merchant system 108, such as via the Internet.

The merchant system 108 may receive the payment details and may electronically transmit the transaction details and payment details to an acquirer processing server 110 using a suitable communication network and method, such as via the payment rails associated with a payment network 112 or another suitable network. In some instances, the payment details and transaction details may be forwarded to the acquirer processing server 110 via one or more intermediate entities, such as a gateway processor. The acquirer processing server 110 may be associated with an acquiring financial institution, such as an acquiring bank, or other entity configured to issue transaction accounts to merchants for use in receiving payments made in payment transactions. The acquirer processing server 110 may be configured to perform the traditional functions of an acquiring financial institution with respect to processing of payment transactions, and may be further configured to participate in settlement of payment transactions via a blockchain.

As part of the processing of the payment transaction, the acquirer processing server 110 may be configured to generate a transaction message for the payment transaction. Transaction messages may be specially formatted data messages that are formatted pursuant to one or more standards governing the exchange of financial transaction messages, such as the International Organization of Standardization's ISO 8583 standard. A transaction message may include a message type indicator indicative of a type of the related payment transaction, such as an authorization request or an authorization response. A transaction message may also include a plurality of data elements, where each data element is configured to store data as set forth in the associated standard(s), which may include the transaction details and payment details. In some instances, a transaction message may also include one or more bitmaps, which may be configured to indicate the data elements included in the transaction message and the data stored therein.

The acquirer processing server 110 may generate a transaction message for the payment transaction based on the transaction details and payment details provided by the merchant system 108. The transaction message may include a message type indicator indicative of an authorization request and a plurality of data elements including at least a first data element configured to store a primary account number read or otherwise received from the payment instrument 106, second data element configured to store a transaction amount, and a third data element configured to store a merchant identifier. The transaction amount may be an amount in a fiat currency associated with the transaction account issued to the consumer 104 and used in the payment transaction. The merchant identifier may be an identification value associated with the merchant involved in the payment transaction, such as a merchant identification number. In some instances, the merchant identifier may be a destination address associated with a blockchain network 114 or a public key used in the generation of a destination address, as discussed in more detail below. In some instances, the merchant identifier may be associated with the acquiring financial institution, such as may be used by the issuing financial in the payment of the transaction amount to the acquiring financial institution for settlement.

The acquirer processing server 110 may electronically transmit the transaction message to the payment network 112 via the associated payment rails. The payment network 112 may receive the transaction message and may perform any necessary services associated with the processing of the payment transaction. Services performed by the payment network 112 may include fraud scoring, the application of transaction controls, account budgeting services, etc. Once any necessary services are performed, the payment network 112 may forward the transaction message to the issuer processing server 102 via the associated payment rails. In some instances, the payment network 112 may identify the issuer processing server 102 via a bank identification number associated therewith being included in the primary account number stored in the corresponding data element included in the received transaction message.

The issuer processing server 102 may receive the transaction message and may then determine approval or denial of the payment transaction using traditional methods and systems. For example, approval of the payment transaction may be based on sufficiency of an account balance for the transaction account issued to the consumer 104 and used in the payment transaction, fraud rules, etc. The issuer processing server 102 may generate a return transaction message for forwarding back to the acquirer processing server 110 via the payment network 112 and associated payment rails. The return transaction message may include a message type indicator indicative of an authorization response and may include a data element configured to store a response code that indicates approval or denial of the payment transaction. In some instances, the return transaction message may be a modification of the transaction message originating from the acquirer processing server 110, such as by modification of the message type indicator and inclusion of the response code in the corresponding data element.

The return transaction message may be electronically transmitted by the issuer processing server 102 to the payment network 112 via the associated payment rails. The payment network 112 may perform any necessary services, such as the modification of transaction controls or account balances depending on the approval or denial of the transaction, and may then forward the return transaction message to the acquirer processing server 110 via the associated payment rails. The acquirer processing server 110 may then inform the merchant system 108 of the approval or denial of the payment transaction. The merchant associated with the merchant system 108 may finalize the payment transaction with the consumer 104 accordingly, such as by informing the consumer 104 of the result and, if the transaction was approved, furnishing the consumer 104 with the transacted-for goods or services.

If the payment transaction is approved, the issuer processing server 102 may perform settlement with the acquirer processing server 110 for the payment transaction. As part of the settlement, the issuer processing server 102 may generate a data message for a blockchain transaction for the payment transaction. The data message may be comprised of at least the fiat transaction amount parsed from the corresponding data element included in the transaction message, the merchant identifier, and a token identifier associated with the transaction account used in the payment transaction. In some instances, the token identifier may be associated with the issuing financial institution and used in blockchain transactions for more than one of the issuing financial institution's transaction accounts. For example, the issuing financial institution may have a single transaction account used for all blockchain transactions. In some embodiments, the data message may also include a reference to the payment transaction, such as a transaction identifier, which may be stored in a corresponding data element included in the received or returned transaction message, as may be generated by the merchant system 108, acquirer processing server 110, or issuer processing server 102. The issuer processing server 102 may electronically transmit the generated data message to a node 116 of the blockchain network 114 using a suitable communication network and method.

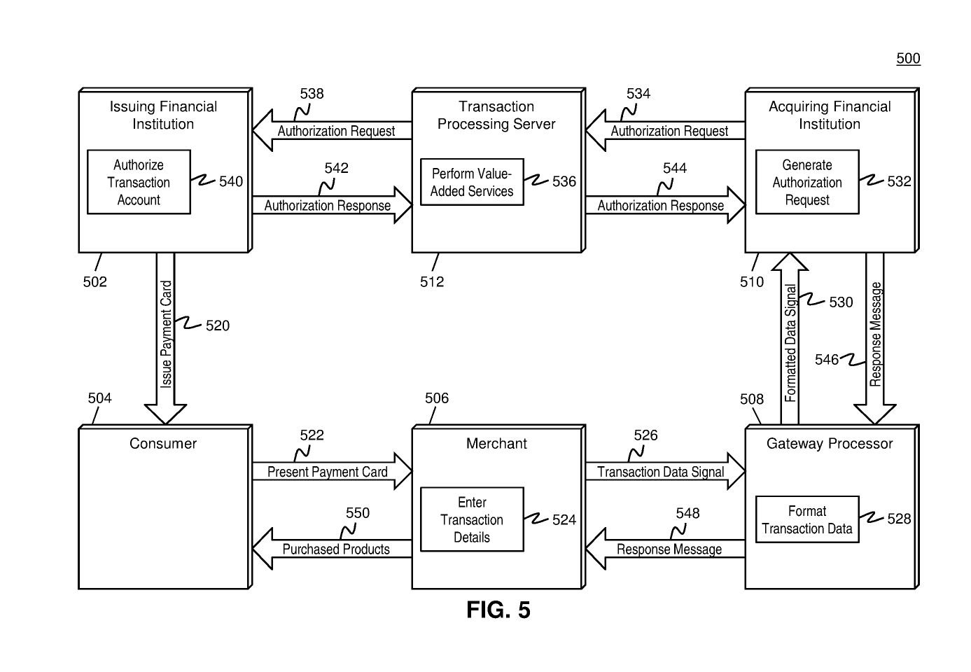

The node 116 may be a suitable computing device or devices configured to post blockchain transactions to the blockchain associated with the blockchain network 114. In some embodiments, the payment network 112 and blockchain network 114 may be a part of the same network. In such an embodiment, a node 116 may be processing device of the payment network 112, such as discussed in more detail below with respect to the process 500 illustrated in FIG. 5.

The node 116 may receive the data message and may post a corresponding blockchain transaction to the blockchain. In some instances, the blockchain transaction may be included in a block of transactions posted to the blockchain, which may be posted following the performance of one or more mathematical computations, such as computations associated with proof of work. In some embodiments, the token identifier may be a source address indicating access to unspent transaction output associated with a prior blockchain transaction involving the issuing financial institution, to be used for payment to the acquiring financial institution. In other embodiments, the token identifier may be a private key associated with the issuing financial institution or reference thereto, for generation of the source address by the node 116. In such embodiments, the source address may be generated by the issuer processing server 102 and provided in the data message in place of the token identifier. In some embodiments, the data message may include, or the node 116 may generate (e.g., on behalf of the issuing financial institution) a digital signature used by the node 116 to verify that the issuing financial institution has access to the indicated currency.

In some embodiments, the node 116 may be configured to calculate a blockchain currency amount. The blockchain currency amount may be an amount of blockchain currency to be transferred from the issuing financial institution to the acquiring financial institution as part of the settlement. In some instances, one or more conversion rates may be used to calculate the blockchain currency amount. In some cases, the blockchain currency amount may be calculated by the issuer processing server 102 and included in the data message in addition to, or in place of, the fiat transaction amount.

In embodiments where the merchant identifier may be an identification value separate from a destination address, the node 116 and/or issuer processing server 102 may be configured to identify a public key associated therewith and may, using the public key, generate a destination address for the blockchain transaction using a suitable algorithm as will be apparent to persons having skill in the relevant art. In instances where the issuer processing server 102 may generate the destination address, the destination address may be included in the data message in addition to, or in place of, the merchant identifier.

The node 116 may post the blockchain transaction to the blockchain for payment of the calculated blockchain currency amount to the destination address associated with the acquiring financial institution and/or merchant. In instances where an unspent transaction output used for the payment may be greater than the calculated blockchain currency amount, the blockchain transaction may also include the payment of a remaining amount (e.g., unspent amount) to a second destination address associated with the issuing financial institution (e.g., generated by the node 116 or the issuer processing server 102 using a public key associated thereto, where the public key may be part of a key pair with the private key used to verify access to the initial unspent transaction output).

Once the blockchain transaction has been posted to the blockchain, the acquirer processing server 110 may receive the updated blockchain from a node 116. The acquirer processing server 110 may verify that the blockchain transaction was posted, and that the correct blockchain currency amount was paid from the issuing financial institution to the acquiring financial institution. In instances where a transaction identifier was supplied, the acquirer processing server 110 may identify the blockchain transaction via the transaction identifier. Once the blockchain payment is verified, the acquirer processing server 110 may credit the transaction account associated with the merchant for the corresponding fiat currency amount.

The methods and systems discussed herein enable the settlement of individualized payment transactions via the use of a blockchain associated with a blockchain network 114. As blockchain transactions may be related to a single payment transaction at a time but the system handle thousands or even millions of such transactions an hour or a day which cannot be done by human thought or on paper, accounting of transaction accounts for merchants may be performed more quickly and more accurately than with traditional settlement schemes. In addition, by using a blockchain for settlement, settlement may be performed faster than in traditional schemes, enabling the acquirer processing server 110 to credit a merchant transaction account in a matter of minutes or hours rather than days or weeks. Furthermore, the use of a blockchain network 114 for settlement may decrease the bandwidth and computing power required by a payment network 112 and the payment rails, which may increase processing speed and efficiency of the payment network 112 for transaction processing, further increasing the speed at which payment transactions may be processed, and settled.

In some instances, the blockchain associated with blockchain network 114 may be a private blockchain. A private blockchain may be a blockchain that can only be posted to by an authorized node 116. In some instances, as used herein “private blockchain” may refer to a private blockchain that is also only accessible by an authorized entity, such as the issuer processing servers 102 and acquirer processing servers 110, for even greater increased security. In the former instances, the blockchain may be publically available such that additional entities (e.g., the merchant involved in the payment transaction) can monitor the status of settlement for their payment transactions. In the latter instances, access to transaction data associated with the consumers 104 and merchants may be more protected.

### Issuer Processing Server

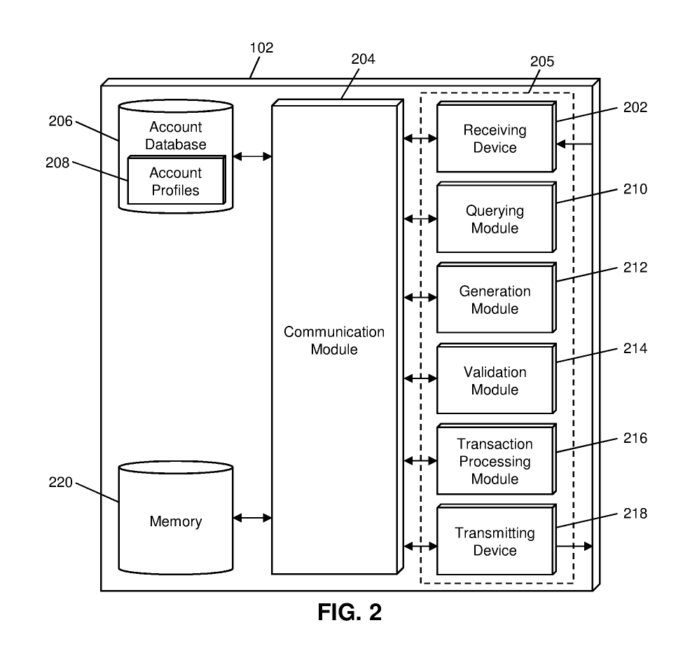

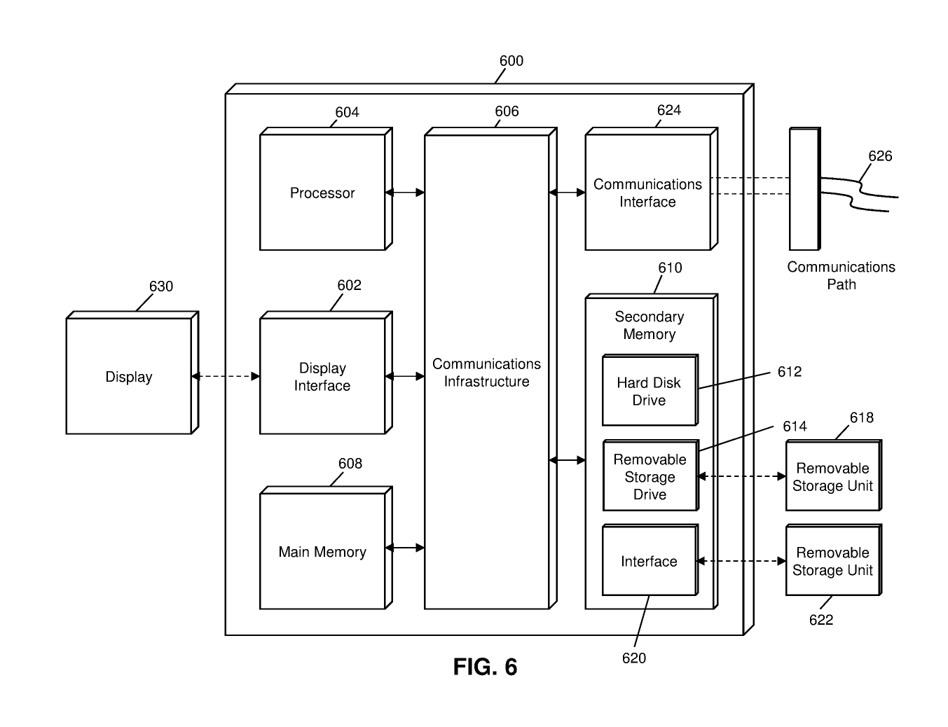

FIG. 2 illustrates an embodiment of the issuer processing server 102 of the system 100. It will be apparent to persons having skill in the relevant art that the embodiment of the issuer processing server 102 illustrated in FIG. 2 is provided as illustration only and may not be exhaustive to all possible configurations of the issuer processing server 102 suitable for performing the functions as discussed herein. For example, the computer system 600 illustrated in FIG. 6 and discussed in more detail below may be a suitable configuration of the issuer processing server 102.

The issuer processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from merchant systems 108, acquirer processing servers 110, payment networks 112, blockchain networks 114, nodes 116, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 112 that may be superimposed or otherwise encoded with transaction messages. Transaction messages may be formatted pursuant to one or more standards, such as the ISO 8583 standard, and include a message type indicator and a plurality of data elements, such as data elements configured to store primary account numbers, transaction amounts, and merchant identifiers. The receiving device 202 may also be configured to receive data signals electronically transmitted by nodes 116 associated with a blockchain network 114 that may be superimposed with a blockchain and associated data, such as for verification of transactions posted to the blockchain.

The issuer processing server 102 may also include a communication module 204. The communication module 204 may be configured to transmit data between modules, engines, databases, memories, and other components of the issuer processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the issuer processing server 102 and external components of the issuer processing server 102, such as externally connected databases, display devices, input devices, etc. The issuer processing server 102 may also include a processing device 205. The processing device 205 may be configured to perform the functions of the issuer processing server 102 discussed herein as will be apparent to persons having skill in the relevant art. In some embodiments, the processing device 205 may include and/or be comprised of a plurality of engines and/or modules specially configured to perform one or more functions of the processing device 205, such as a querying module 210, generation module 212, validation module 214, transaction processing module 216, etc. As used herein, the term “module” may be software or hardware particularly programmed to receive an input, perform one or more processes using the input, and provide an output. The input, output, and processes performed by various modules will be apparent to one skilled in the art based upon the present disclosure.

The issuer processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least a primary account number corresponding to the related transaction account and a fiat currency balance. The fiat currency balance may be a balance associated with a fiat currency used in payment transactions funded via the related transaction account. The balance may be an amount available for use, an outstanding balance, a remaining credit limit, or other suitable balance as will be apparent to persons having skill in the relevant art.

The issuer processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the issuer processing server 102 as necessary. The querying module 210 may, for example, execute a query on the account database 206 to identify an account profile 208 related to a transaction account involved in a payment transaction where the included primary account number corresponds to the primary account number stored in a corresponding data element included in a transaction message received by the receiving device 202 for the payment transaction. The querying module 210 may also be configured to execute queries on the account database 206 to adjust the fiat currency balance for an account profile 208 based on a payment transaction that is approved.

The issuer processing server 102 may also include a generation module 212. The generation module 212 may be configured to generate transaction messages and other data messages. The generation module 212 may receive data and an instruction as input, may generate a transaction message or data message as instructed using the supplied data, and output the generated transaction or data message to another module or engine of the issuer processing server 102 for use thereof. The generation module 212 may be configured to generate transaction messages that include message type indicators indicative of an authorization response that include a plurality of data elements, including data elements corresponding to those included in a received authorization request, as well as a data element configured to store a response code indicating that the related payment transaction is approved or denied. In some instances, the generation module 212 may generate an authorization response via modification of a received authorization request. The generation module 212 may also be configured to generate blockchain transactions or data messages for use in the generation thereof (e.g., by a node 116), which may include at least a token identifier or source address, a fiat currency amount or blockchain currency amount, and a merchant identifier or destination address. In some instances, the generation module 212 may be further configured to calculate a blockchain currency amount from a fiat currency amount (e.g., as stored in a data element of a transaction message configured to store a transaction amount) using one or more conversion rates and/or algorithms.

The issuer processing server 102 may also include a validation module 214. The validation module 214 may receive two or more data values or data sets where at least one is indicated for validation, may validate the indicated data value or data set based on a correspond of the indicated data value or data set to the other data values or data sets supplied, and may output the result of the validation to another engine or module of the issuer processing server 102. For instance, the validation module 214 may be configured to validate that a transaction account has a sufficient balance for a payment transaction based on the fiat currency balance included in an account profile 208 identified (e.g., via the querying module 210) for a payment transaction as compared to the fiat transaction amount stored in a corresponding data element included in an authorization request received (e.g., via the receiving device 202) for the payment transaction. The validation module 214 may also be configured to validate blockchain transactions posted to the blockchain associated with the blockchain network 114, such as to verify a submitted blockchain transaction is posted to complete settlement, such as prior to adjusting the related account profile's account balance.

The issuer processing server 102 may also include a transaction processing module 216. The transaction processing module 216 may be configured to perform functions related to the processing of payment transactions. For example, the transaction processing module 216 may be configured to apply fraud rules to a transaction message, determine approval or denial of a payment transaction, apply transaction controls to a payment transaction, swap primary account numbers, adjust data stored in data elements included in a transaction message, instruct the querying module 210 to adjust account balances or other data in account profiles 208 based on payment transactions, etc. Additional functions that may be performed by the transaction processing module 216 will be apparent to persons having skill in the relevant art.

The issuer processing server 102 may also include a transmitting device 218. The transmitting device 218 may be configured to transmit data over one or more networks via one or more network protocols. In some embodiments, the transmitting device 218 may be configured to transmit data over the payment rails, such as using specially configured infrastructure associated with payment networks 112 for the transmission of transaction messages that include sensitive financial data and information, such as identified payment credentials. In some instances, the transmitting device 218 may be configured to transmit data to merchant systems 108, acquirer processing servers 110, payment networks 112, blockchain networks 114, nodes 116, and other entities via alternative networks, such as the Internet. In some embodiments, the transmitting device 218 may be comprised of multiple devices, such as different transmitting devices for transmitting data over different networks, such as a first transmitting device for transmitting data over the payment rails and a second transmitting device for transmitting data over the Internet. The transmitting device 218 may electronically transmit data signals that have data superimposed that may be parsed by a receiving computing device. In some instances, the transmitting device 218 may include one or more modules for superimposing, encoding, or otherwise formatting data into data signals suitable for transmission.

The transmitting device 218 may be configured to electronically transmit data signals to payment networks 112 that are superimposed with transaction messages. The transaction messages may be formatted pursuant to one or more standards, such as the ISO 8583 standard, and include a message type indicator (e.g., indicative of an authorization response) and a plurality of data elements, which may include a data element configured to store a response code indicating that the related payment transaction is approved or denied (e.g., as determined via the transaction processing module 216 and/or validation module 214). The transmitting device 218 may also be configured to electronically transmit data signals to a node 116 associated with a blockchain network 114 that may be superimposed or otherwise encoded with blockchain transactions or data messages used in the generation thereof, such as may include token identifiers, source addresses, public keys, private keys, digital signatures, fiat currency amounts, blockchain transaction amounts, merchant identifiers, destination addresses, etc.

The issuer processing server 102 may also include a memory 220. The memory 220 may be configured to store data for use by the issuer processing server 102 in performing the functions discussed herein. The memory 220 may be configured to store data using suitable data formatting methods and schema and may be any suitable type of memory, such as read-only memory, random access memory, etc. The memory 220 may include, for example, encryption keys and algorithms, communication protocols and standards, data formatting standards and protocols, program code for modules and application programs of the processing device, and other data that may be suitable for use by the issuer processing server 102 in the performance of the functions disclosed herein as will be apparent to persons having skill in the relevant art. In some embodiments, the memory 220 may be comprised of or may otherwise include a relational database that utilizes structured query language for the storage, identification, modifying, updating, accessing, etc. of structured data sets stored therein.

### Process for Settlement of a Transaction Using a Blockchain

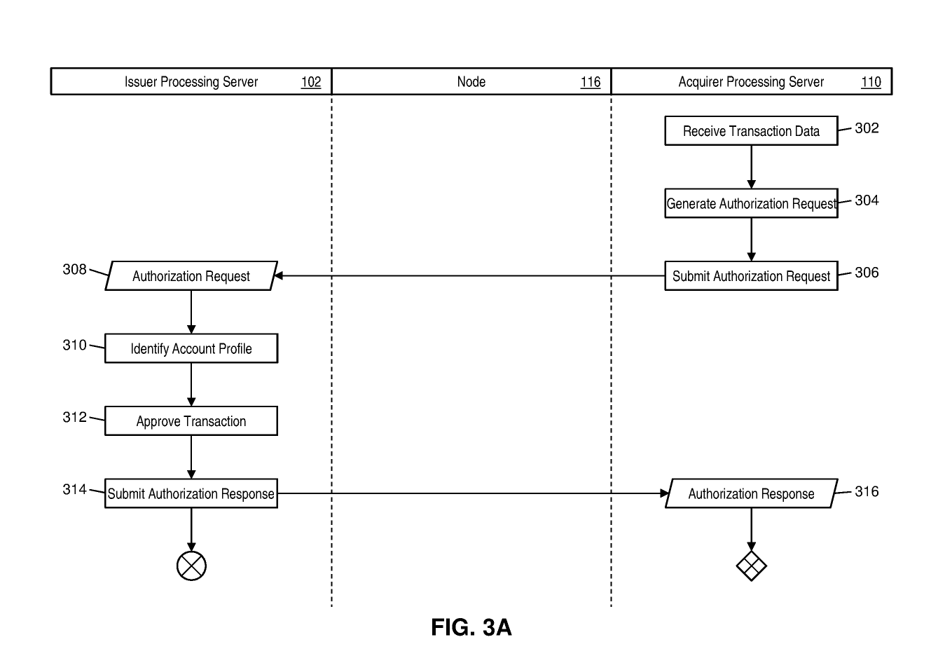

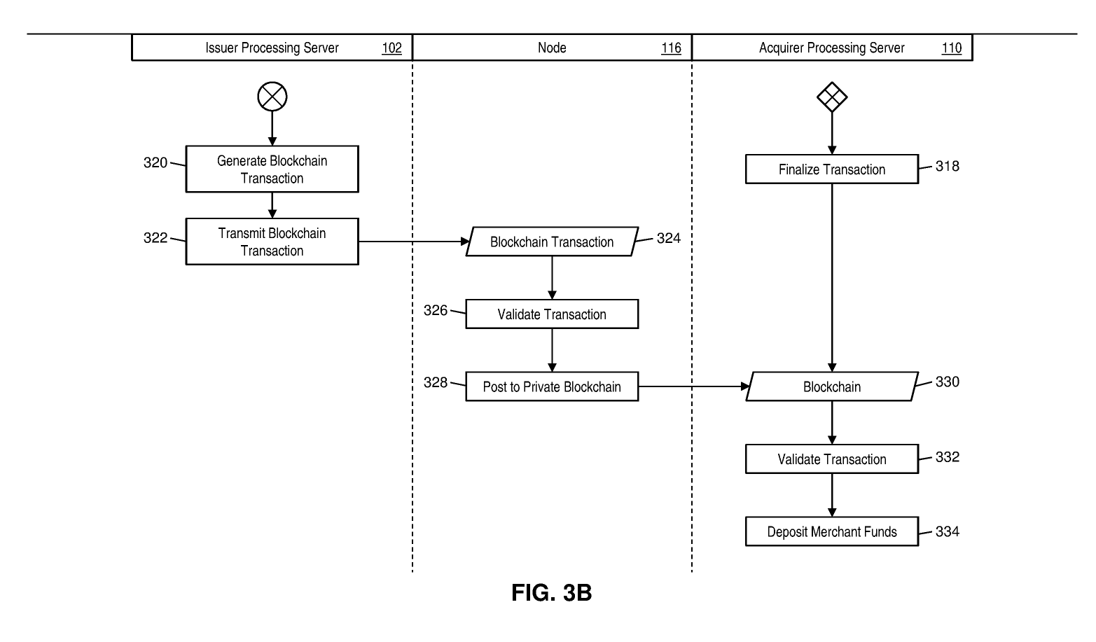

FIGS. 3A and 3B illustrate a process for the settlement of a payment transaction between an issuing financial institution and acquiring financial institution via the use of a blockchain.

In step 302, the acquirer processing server 110 may receive transaction data for a payment transaction. The transaction data may be received from a merchant system 108 either directly via a suitable communication network and method, which may include the payment rails associated with the payment network 112, or via one or more intermediate entities, such as a gateway processor. The transaction data may include payment details, including at least a primary account number read or otherwise obtained from a payment instrument 106 provided by a consumer 104 involved in the payment transaction, and other transaction details, including at least a transaction amount, merchant identifier, and other data, which may include a transaction time, transaction date, geographic location, point of sale data, merchant data, consumer data, product data, offer data, reward data, loyalty data, issuer data, acquirer data, etc.

In step 304, the acquirer processing server 110 may generate an authorization request for the payment transaction. The authorization request may be a transaction message formatted pursuant to one or more standards, such as the ISO 8583 standard, that includes a message type indicator indicative of an authorization request and a plurality of data elements configured to store the transaction data received from the merchant system 108. In step 306, the acquirer processing server 110 may submit the authorization request to the payment network 112 via the payment rails for forwarding to the issuer processing server 102.

In step 308, the receiving device 202 of the issuer processing server 102 may receive the authorization request as forwarded by the payment network 112 via the associated payment rails. In step 310, the querying module 210 of the issuer processing server 102 may execute a query on the account database 206 included therein to identify an account profile 208 related to the payment transaction. The identified account profile 208 may include a primary account number corresponding to the primary account number stored in a corresponding data element included in the received authorization request.

In step 312, the transaction processing module 216 of the issuer processing server 102 may approve the payment transaction. The approval may be based on at least a sufficiency of the fiat currency balance stored in the identified account profile 208 as compared to the transaction amount stored in a corresponding data element included in the received authorization request, and any other considerations, such as based on fraud rules, transaction controls, etc. As part of the approval, the querying module 210 may execute a query on the identified account profile 208 to adjust the fiat currency balance accordingly (e.g., deducting an available spending amount by the transaction amount) and the generation module 212 of the issuer processing server 102 may generate an authorization response for the payment transaction. The authorization response may be a transaction message (e.g., newly generated or a modification of the authorization request) that is formatted pursuant to one or more standards, such as the ISO 8583 standard, that includes a message type indicator indicative of an authorization response and the plurality of data elements included in the authorization request that also or alternatively includes a data element configured to store a response code indicating that the payment transaction is approved.

In step 314, the transmitting device 218 of the issuer processing server 102 may electronically transmit the authorization response to the payment network 112 via the associated payment rails for forwarding to the acquirer processing server 110. In step 316, the acquirer processing server 110 may receive the authorization response for the payment transaction. In step 318, the acquirer processing server 110 may finalize the payment transaction. Finalization of the payment transaction may include informing the merchant system 108 of the approval such that the associated merchant may furnish the consumer 104 involved in the payment transaction with the transacted-for goods or services, the shipping of products to the consumer 104, etc.

In step 320, the generation module 212 of the issuer processing server 102 may generate a blockchain transaction for settlement of the payment transaction. The blockchain transaction may include at least a token identifier, a blockchain currency amount, and a destination address. The token identifier may be included in the identified account profile 208 or may be associated with the issuer processing server 102 generally, such as may be stored in and identified from the memory 220. In some instances, the generation module 212 may be configured to generate the token identifier from a private key. In some cases, the token identifier may include or be comprised of a digital signature. The blockchain currency amount may be calculated by a suitable module or engine of the issuer processing server 102 based on the fiat currency amount stored in a corresponding data element of the authorization request and/or authorization response. The destination address may be the merchant identifier stored in a corresponding data element included in the authorization request, or may be generated based thereon, such as in instances where the merchant identifier may be a public key associated with the merchant involved in the payment transaction or the acquirer processing server 110.

In step 322, the transmitting device 218 of the issuer processing server 102 may electronically transmit a data signal superimposed with the generated blockchain transaction to a node 116 associated with a blockchain network 114 corresponding to the blockchain to which the generated blockchain transaction is to be posted. In step 324, the node 116 may receive the blockchain transaction. In step 326, the node 116 may validate the transaction using methods and systems that will be apparent to persons having skill in the relevant art, such as by validating the source address and/or digital signature, accessibility of the source address to a suitable amount of blockchain currency, etc. Once the transaction is validated, then, in step 328, the node 116 may post the blockchain transaction to the private blockchain. In some instances, the blockchain transaction may be posted as part of a block of blockchain transactions. In some cases, the posted block and/or blockchain transaction may be further validated by one or more additional nodes in the blockchain network 114.

In step 330, the acquirer processing server 110 may retrieve the blockchain from the blockchain network 114. In some instances, the blockchain may be a private blockchain. In such an instance, the acquirer processing server 110 may be require to provide data indicating that the acquirer processing server 110 is authorized to access the blockchain, such as by providing authentication information. In step 332, the acquirer processing server 110 may validate the blockchain transaction, such as by confirming that the blockchain currency amount corresponds to the transaction amount submitted in the authorization request, that the destination address is correct, etc. Once the blockchain transaction is validated, the acquirer processing server 110 may deposit the corresponding fiat currency into a transaction account associated with the merchant involved in the payment transaction. The merchant may thus receive payment for the payment transaction as quickly as the blockchain transaction may be validated and posted to the blockchain, which may significantly reduce settlement time and the time at which the merchant may receive payment.

### Exemplary Method for Submitting Data Captured in a Transaction Message to a Blockchain

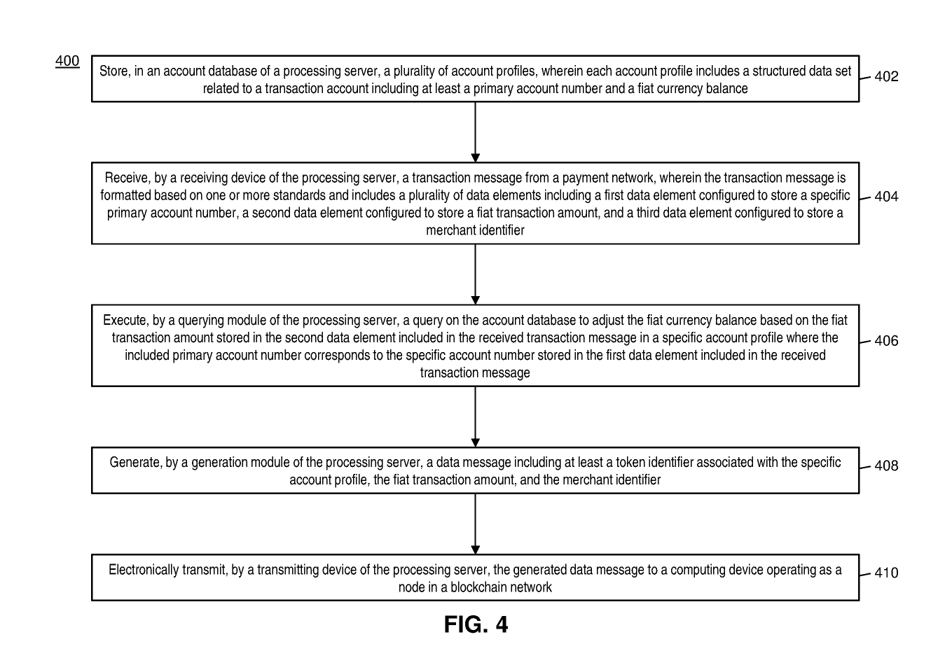

FIG. 4 illustrates a method 400 for the submitting of data captured in a transaction message for a payment transaction to a blockchain for posting in a blockchain transaction used for settlement of the payment transaction between an issuing financial institution and acquiring financial institution.

In step 402, a plurality of account profiles (e.g., account profiles 208) may be stored in an account database (e.g., the account database 206) of a processing server (e.g., the issuer processing server 102), wherein each account profile includes a structured data set related to a transaction account including at least a primary account number and a fiat currency balance. In step 404, a transaction message may be received from a payment network (e.g., the payment network 112) by a receiving device (e.g., the receiving device 202) of the processing server, wherein the transaction message is formatted based on one or more standards and includes a plurality of data elements including a first data element configured to store a specific primary account number, a second data element configured to store a fiat transaction amount, and a third data element configured to store a merchant identifier.

In step 406, a query may be executed by a querying module (e.g., the querying module 210) of the processing server on the account database to adjust the fiat currency balance based on the fiat transaction amount stored in the second data element included in the received transaction message in a specific account profile where the included primary account number corresponds to the specific account number stored in the first data element included in the received transaction message. In step 408, a data message may be generated by a generation module (e.g., the generation module 212) of the processing server, wherein the data message includes at least a token identifier associated with the specific account profile, the fiat transaction amount, and the merchant identifier. In step 410, the generated data message may be electronically transmitted by a transmitting device (e.g., the transmitting device 218) of the processing server to a computing device (e.g., node 116) operating as a node in a blockchain network (e.g., the blockchain network 114).

In one embodiment, the method 400 may also include validating, by a validation module (e.g., the validation module 214) of the processing server, sufficiency of the fiat currency balance included in the specific account profile to cover the fiat transaction amount stored in the second data element included in the received transaction message. In some embodiments, the transaction message may further include a message type indicator indicative of an authorization request. In one embodiment, the merchant identifier may be a destination address associated with the blockchain network.

In one embodiment, the merchant identifier may be a public key of a key pair associated with the blockchain network used in the generation of a destination address. In some embodiments, the merchant identifier may be a transaction account number associated with a transaction account. In one embodiment, the blockchain network may be a private blockchain network.

In some embodiments, the method 400 may further include: generating, by the generation module of the processing server, a return message, wherein the return message is formatted based on the one or more standards and includes at least a fourth data element configured to store a response code indicating approval; and electronically transmitting, by the transmitting device of the processing server, the generated return message to the payment network. In a further embodiment, the computing device may be associated with the payment network. In another further embodiment, the return message may further include a message type indicator indicative of an authorization response.

### Payment Transaction Processing System and Process

FIG. 5 illustrates a transaction processing system and a process 500 for the processing of payment transactions in the system, which may include the processing of thousands, millions, or even billions of transactions during a given period (e.g., hourly, daily, weekly, etc.). The process 500 and steps included therein may be performed by one or more components of the system 100 discussed above, such as the issuer processing server 102, consumer 104, payment instrument 106, merchant system 108, acquirer processing server 110, payment network 112, etc. The processing of payment transactions using the system and process 500 illustrated in FIG. 5 and discussed below may utilize the payment rails, which may be comprised of the computing devices and infrastructure utilized to perform the steps of the process 500 as specially configured and programmed by the entities discussed below, including the transaction processing server 512, which may be associated with one or more payment networks configured to processing payment transactions. It will be apparent to persons having skill in the relevant art that the process 500 may be incorporated into the processes illustrated in FIGS. 3A, 3B, and 4, discussed above, with respect to the step or steps involved in the processing of a payment transaction. In addition, the entities discussed herein for performing the process 500 may include one or more computing devices or systems configured to perform the functions discussed below. For instance, the merchant 506 may be comprised of one or more point of sale devices, a local communication network, a computing server, and other devices configured to perform the functions discussed below.

In step 520, an issuing financial institution 502 may issue a payment card or other suitable payment instrument to a consumer 504. The issuing financial institution may be a financial institution, such as a bank, or other suitable type of entity that administers and manages payment accounts and/or payment instruments for use with payment accounts that can be used to fund payment transactions. The consumer 504 may have a transaction account with the issuing financial institution 502 for which the issued payment card is associated, such that, when used in a payment transaction, the payment transaction is funded by the associated transaction account. In some embodiments, the payment card may be issued to the consumer 504 physically. In other embodiments, the payment card may be a virtual payment card or otherwise provisioned to the consumer 504 in an electronic format.

In step 522, the consumer 504 may present the issued payment card to a merchant 506 for use in funding a payment transaction. The merchant 506 may be a business, another consumer, or any entity that may engage in a payment transaction with the consumer 504. The payment card may be presented by the consumer 504 via providing the physical card to the merchant 506, electronically transmitting (e.g., via near field communication, wireless transmission, or other suitable electronic transmission type and protocol) payment details for the payment card, or initiating transmission of payment details to the merchant 506 via a third party. The merchant 506 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 524, the merchant 506 may enter transaction details into a point of sale computing system. The transaction details may include the payment details provided by the consumer 504 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 506 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 506 may be an online retailer in an e-commerce transaction. In such embodiments, the transaction details may be entered in a shopping cart or other repository for storing transaction data in an electronic transaction as will be apparent to persons having skill in the relevant art.

In step 526, the merchant 506 may electronically transmit a data signal superimposed with transaction data to a gateway processor 508. The gateway processor 508 may be an entity configured to receive transaction details from a merchant 506 for formatting and transmission to an acquiring financial institution 510. In some instances, a gateway processor 508 may be associated with a plurality of merchants 506 and a plurality of acquiring financial institutions 510. In such instances, the gateway processor 508 may receive transaction details for a plurality of different transactions involving various merchants, which may be forwarded on to appropriate acquiring financial institutions 510. By having relationships with multiple acquiring financial institutions 510 and having the requisite infrastructure to communicate with financial institutions using the payment rails, such as using application programming interfaces associated with the gateway processor 508 or financial institutions used for the submission, receipt, and retrieval of data, a gateway processor 508 may act as an intermediary for a merchant 506 to be able to conduct payment transactions via a single communication channel and format with the gateway processor 508, without having to maintain relationships with multiple acquiring financial institutions 510 and payment processors and the hardware associated thereto. Acquiring financial institutions 510 may be financial institutions, such as banks, or other entities that administers and manages payment accounts and/or payment instruments for use with payment accounts. In some instances, acquiring financial institutions 510 may manage transaction accounts for merchants 506. In some cases, a single financial institution may operate as both an issuing financial institution 502 and an acquiring financial institution 510.

The data signal transmitted from the merchant 506 to the gateway processor 508 may be superimposed with the transaction details for the payment transaction, which may be formatted based on one or more standards. In some embodiments, the standards may be set forth by the gateway processor 508, which may use a unique, proprietary format for the transmission of transaction data to/from the gateway processor 508. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 508.

In step 528, the gateway processor 508 may parse the transaction data signal to obtain the transaction data superimposed thereon and may format the transaction data as necessary. The formatting of the transaction data may be performed by the gateway processor 508 based on the proprietary standards of the gateway processor 508 or an acquiring financial institution 510 associated with the payment transaction. The proprietary standards may specify the type of data included in the transaction data and the format for storage and transmission of the data. The acquiring financial institution 510 may be identified by the gateway processor 508 using the transaction data, such as by parsing the transaction data (e.g., deconstructing into data elements) to obtain an account identifier included therein associated with the acquiring financial institution 510. In some instances, the gateway processor 508 may then format the transaction data based on the identified acquiring financial institution 510, such as to comply with standards of formatting specified by the acquiring financial institution 510. In some embodiments, the identified acquiring financial institution 510 may be associated with the merchant 506 involved in the payment transaction, and, in some cases, may manage a transaction account associated with the merchant 506.

In step 530, the gateway processor 508 may electronically transmit a data signal superimposed with the formatted transaction data to the identified acquiring financial institution 510. The acquiring financial institution 510 may receive the data signal and parse the signal to obtain the formatted transaction data superimposed thereon. In step 532, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 506 involved in the payment transaction is requesting payment or a promise of payment from the issuing financial institution 502 for the transaction. The authorization request may include a plurality of data elements, each data element being configured to store data as set forth in the associated standards, such as for storing an account number, application cryptogram, transaction amount, issuing financial institution 502 information, etc.

In step 534, the acquiring financial institution 510 may electronically transmit the authorization request to a transaction processing server 512 for processing. The transaction processing server 512 may be comprised of one or more computing devices as part of a payment network configured to process payment transactions. In some embodiments, the authorization request may be transmitted by a transaction processor at the acquiring financial institution 510 or other entity associated with the acquiring financial institution. The transaction processor may be one or more computing devices that include a plurality of communication channels for communication with the transaction processing server 512 for the transmission of transaction messages and other data to and from the transaction processing server 512. In some embodiments, the payment network associated with the transaction processing server 512 may own or operate each transaction processor such that the payment network may maintain control over the communication of transaction messages to and from the transaction processing server 512 for network and informational security.

In step 536, the transaction processing server 512 may perform value-added services for the payment transaction. Value-added services may be services specified by the issuing financial institution 502 that may provide additional value to the issuing financial institution 502 or the consumer 504 in the processing of payment transactions. Value-added services may include, for example, fraud scoring, transaction or account controls, account number mapping, offer redemption, loyalty processing, etc. For instance, when the transaction processing server 512 receives the transaction, a fraud score for the transaction may be calculated based on the data included therein and one or more fraud scoring algorithms and/or engines. In some instances, the transaction processing server 512 may first identify the issuing financial institution 502 associated with the transaction, and then identify any services indicated by the issuing financial institution 502 to be performed. The issuing financial institution 502 may be identified, for example, by data included in a specific data element included in the authorization request, such as an issuer identification number. In another example, the issuing financial institution 502 may be identified by the primary account number stored in the authorization request, such as by using a portion of the primary account number (e.g., a bank identification number) for identification. In some instances, the transaction processing server 512 may also be configured to perform value-added services for other entities involved in the payment transaction, such as the merchant 506 or acquiring financial institution 510, such as credit scoring or fraud scoring.

In step 538, the transaction processing server 512 may electronically transmit the authorization request to the issuing financial institution 502. In some instances, the authorization request may be modified, or additional data included in or transmitted accompanying the authorization request as a result of the performance of value-added services by the transaction processing server 512. In some embodiments, the authorization request may be transmitted to a transaction processor (e.g., owned or operated by the transaction processing server 512) situated at the issuing financial institution 502 or an entity associated thereof, which may forward the authorization request to the issuing financial institution 502.

In step 540, the issuing financial institution 502 may authorize the transaction account for payment of the payment transaction. The authorization may be based on an available credit amount for the transaction account and the transaction amount for the payment transaction, fraud scores provided by the transaction processing server 512, and other considerations that will be apparent to persons having skill in the relevant art. The issuing financial institution 502 may modify the authorization request to include a response code indicating approval (e.g., or denial if the transaction is to be denied) of the payment transaction. The issuing financial institution 502 may also modify a message type indicator for the transaction message to indicate that the transaction message is changed to be an authorization response. In step 542, the issuing financial institution 502 may transmit (e.g., via a transaction processor) the authorization response to the transaction processing server 512.

In step 544, the transaction processing server 512 may forward the authorization response to the acquiring financial institution 510 (e.g., via a transaction processor). In step 546, the acquiring financial institution may generate a response message indicating approval or denial of the payment transaction as indicated in the response code of the authorization response, and may transmit the response message to the gateway processor 508 using the standards and protocols set forth by the gateway processor 508. In step 548, the gateway processor 508 may forward the response message to the merchant 506 using the appropriate standards and protocols. In step 550, assuming the transaction was approved, the merchant 506 may then provide the products purchased by the consumer 504 as part of the payment transaction to the consumer 504.

In some embodiments, once the process 500 has completed, payment from the issuing financial institution 502 to the acquiring financial institution 510 may be performed. In some instances, the payment may be made immediately or within one business day. In other instances, the payment may be made after a period of time, and in response to the submission of a clearing request from the acquiring financial institution 510 to the issuing financial institution 502 via the transaction processing server 502. In such instances, clearing requests for multiple payment transactions may be aggregated into a single clearing request, which may be used by the transaction processing server 512 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 540), the transaction processing server 512 may be configured to perform authorization of transactions on behalf of the issuing financial institution 502. Such actions may be referred to as “stand-in processing,” where the transaction processing server “stands in” as the issuing financial institution 502. In such instances, the transaction processing server 512 may utilize rules set forth by the issuing financial institution 502 to determine approval or denial of the payment transaction, and may modify the transaction message accordingly prior to forwarding to the acquiring financial institution 510 in step 544. The transaction processing server 512 may retain data associated with transactions for which the transaction processing server 512 stands in, and may transmit the retained data to the issuing financial institution 502 once communication is reestablished. The issuing financial institution 502 may then process transaction accounts accordingly to accommodate for the time of lost communication.

In another example, if the transaction processing server 512 is unavailable for submission of the authorization request by the acquiring financial institution 510, then the transaction processor at the acquiring financial institution 510 may be configured to perform the processing of the transaction processing server 512 and the issuing financial institution 502. The transaction processor may include rules and data suitable for use in making a determination of approval or denial of the payment transaction based on the data included therein. For instance, the issuing financial institution 502 and/or transaction processing server 512 may set limits on transaction type, transaction amount, etc. that may be stored in the transaction processor and used to determine approval or denial of a payment transaction based thereon. In such instances, the acquiring financial institution 510 may receive an authorization response for the payment transaction even if the transaction processing server 512 is unavailable, ensuring that transactions are processed and no downtime is experienced even in instances where communication is unavailable. In such cases, the transaction processor may store transaction details for the payment transactions, which may be transmitted to the transaction processing server 512 (e.g., and from there to the associated issuing financial institutions 502) once communication is reestablished.

In some embodiments, transaction processors may be configured to include a plurality of different communication channels, which may utilize multiple communication cards and/or devices, to communicate with the transaction processing server 512 for the sending and receiving of transaction messages. For example, a transaction processor may be comprised of multiple computing devices, each having multiple communication ports that are connected to the transaction processing server 512. In such embodiments, the transaction processor may cycle through the communication channels when transmitting transaction messages to the transaction processing server 512, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 510 may identify that an authorization request involves an issuing financial institution 502 (e.g., via the bank identification number included in the transaction message) for which no value-added services are required. The transaction processor at the acquiring financial institution 510 may then transmit the authorization request directly to the transaction processor at the issuing financial institution 502 (e.g., without the authorization request passing through the transaction processing server 512), where the issuing financial institution 502 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 512 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 508, acquiring financial institution 510, etc.) for processing using this advanced network, and to quickly and efficiently receive a response regarding the ability for a consumer 504 to fund the payment transaction.

### Computer System Architecture

FIG. 6 illustrates a computer system 600 in which embodiments of the present disclosure, or portions thereof, may be implemented as computer-readable code. For example, the issuer processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4, and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, 4, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for submitting data captured in a transaction message to a blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for submitting data captured in a transaction message to a blockchain, comprising:
storing, in an account database of a processing server, a plurality of account profiles, wherein each account profile includes a structured data set related to a transaction account including at least a primary account number and a fiat currency balance;
receiving, by a receiving device of the processing server, a transaction message from a payment network, wherein the transaction message is formatted based on one or more standards and includes a plurality of data elements including a first data element configured to store a specific primary account number, a second data element configured to store a fiat transaction amount, and a third data element configured to store a merchant identifier;
execute, by a querying module of the processing server, a query on the account database to adjust the fiat currency balance based on the fiat transaction amount stored in the second data element included in the received transaction message in a specific account profile where the included primary account number corresponds to the specific account number stored in the first data element included in the received transaction message;
generating, by a generation module of the processing server, a data message including at least a token identifier associated with the specific account profile, the fiat transaction amount, and the merchant identifier; and
electronically transmitting, by a transmitting device of the processing server, the generated data message to a computing device operating as a node in a blockchain network.

2. The method of claim 1, further comprising:
validating, by a validation module of the processing server, sufficiency of the fiat currency balance included in the specific account profile to cover the fiat transaction amount stored in the second data element included in the received transaction message.

3. The method of claim 1, further comprising:
generating, by the generation module of the processing server, a return message, wherein the return message is formatted based on the one or more standards and includes at least a fourth data element configured to store a response code indicating approval; and
electronically transmitting, by the transmitting device of the processing server, the generated return message to the payment network.

4. The method of claim 3, wherein the computing device is associated with the payment network.

5. The method of claim 3, wherein the return message further includes a message type indicator indicative of an authorization response.

6. The method of claim 1, wherein the transaction message further includes a message type indicator indicative of an authorization request.

7. The method of claim 1, wherein the merchant identifier is a destination address associated with the blockchain network.

8. The method of claim 1, wherein the merchant identifier is a public key of a key pair associated with the blockchain network used in the generation of a destination address.

9. The method of claim 1, wherein the merchant identifier is a transaction account number associated with a transaction account.

10. The method of claim 1, wherein the blockchain network is a private blockchain network.

11. A system for submitting data captured in a transaction message to a blockchain, comprising:
an account database of a processing server configured to store a plurality of account profiles, wherein each account profile includes a structured data set related to a transaction account including at least a primary account number and a fiat currency balance;
a receiving device of the processing server configured to receive a transaction message from a payment network, wherein the transaction message is formatted based on one or more standards and includes a plurality of data elements including a first data element configured to store a specific primary account number, a second data element configured to store a fiat transaction amount, and a third data element configured to store a merchant identifier;
a querying module of the processing server configured to execute a query on the account database to adjust the fiat currency balance based on the fiat transaction amount stored in the second data element included in the received transaction message in a specific account profile where the included primary account number corresponds to the specific account number stored in the first data element included in the received transaction message;
a generation module of the processing server configured to generate a data message including at least a token identifier associated with the specific account profile, the fiat transaction amount, and the merchant identifier; and
a transmitting device of the processing server configured to electronically transmit the generated data message to a computing device operating as a node in a blockchain network.

12. The system of claim 11, further comprising:
a validation module of the processing server configured to validate sufficiency of the fiat currency balance included in the specific account profile to cover the fiat transaction amount stored in the second data element included in the received transaction message.

13. The system of claim 11, wherein
the generation module of the processing server is further configured to generate a return message, wherein the return message is formatted based on the one or more standards and includes at least a fourth data element configured to store a response code indicating approval; and
the transmitting device of the processing server is further configured to electronically transmit the generated return message to the payment network.

14. The system of claim 13, wherein the computing device is associated with the payment network.

15. The system of claim 13, wherein the return message further includes a message type indicator indicative of an authorization response.

16. The system of claim 11, wherein the transaction message further includes a message type indicator indicative of an authorization request.

17. The system of claim 11, wherein the merchant identifier is a destination address associated with the blockchain network.

18. The system of claim 11, wherein the merchant identifier is a public key of a key pair associated with the blockchain network used in the generation of a destination address.

19. The system of claim 11, wherein the merchant identifier is a transaction account number associated with a transaction account.

20. The system of claim 11, wherein the blockchain network is a private blockchain network.
